(19) United States
(12) Patent Application Publication
(10) Pub. No.: US 2022/0371705 A1
(43) Pub. Date: Nov. 24, 2022

(54) METHOD FOR PROVIDING A LOCATION-SPECIFIC MACHINE LEARNING MODEL

(71) Applicant: Awake.AI Oy, Turku (FI)

(72) Inventors: Jussi Poikonen, Turku (FI); Karno Tenovuo, Turku (FI)

(73) Assignee: Awake.AI Oy, Turku (FI)

(21) Appl. No.: 17/772,013

(22) PCT Filed: Nov. 4, 2020
(86) PCT No.: PCT/FI2020/050724

§ 371 Date: Apr. 26, 2022

(30) Foreign Application Priority Data
Nov. 11, 2019 (FI) 20195961

(51) Int. Cl. B63B 49/00; H04L 67/12; G01C 21/20; G06N 20/00

(52) U.S. Cl. CPC B63B 49/00; H04L 67/12; G01C 21/203; G06N 20/00; G06V 20/50

(57) ABSTRACT

A method for providing a location-specific machine learning model from a harbor operating system to an on-board processing system of a vessel is provided. The method includes predetermining a geographical area of an area of a harbor, creating communication between the harbor operating system and the on-board processing system of the vessel, receiving a specification of the vessel from the on-board processing system of the vessel, at the harbor operating system. The received specification is used for preparing and providing at least one software container according to the received specification of the vessel, wherein the at least one software container includes the location-specific machine learning model. The at least one software container received by the on-board processing system of the vessel is activated by using the at least one provided software container activation means.

### TECHNICAL FIELD

The present disclosure relates generally to location-specific models to extract semantic information from the sensor measurements for situational awareness based on external sensors of the vessels and more specifically to a system and method using machine learning for obtaining information on the vessel's surroundings for the purpose of estimating the location of the vessel and surrounding objects of the vessel to help to navigate the vessel from the offshore area to dock in the harbor.

### BACKGROUND

Multiple sensors are used on-board vessels to obtain data on vessel surroundings. Examples of such sensors in modern vessels are visual and thermal camera systems, radars, sonars, lidars, etc. Machine learning-based computational methods are used to extract semantic information from sensor data, especially from sensors such as cameras and lidars, which contain sufficiently detailed features to enable identification of object types. Furthermore, machine learning models may be used in control systems, e.g. for vessel path planning and navigation.

Machine learning models are data-dependent, i.e. the data used to train a given machine learning model must sufficiently represent the possible inputs that the model will apply during operation. Thus, for models specific to location-specific features such as local landmarks, navigational aids, vessel types, or navigational requirements, data needs to be collected for model training from each distinct operation environment.

Machine learning models can be used, for example, to identify objects and features from camera images or 3D sensor data such as lidar measurements. Automatic identification of static landmarks, combined with information on the exact locations of such landmarks, can be used to estimate the location of a vessel with high accuracy. Locally trained machine learning models can also be used to identify e.g. vessels typically operating in the area, which combined with metadata e.g., on their typical routes and schedules, can be used for navigation decisions. Furthermore, models can be provided to automatically identify and locate port infrastructure elements of the harbor, such as piers, cranes, etc.

The local model services are applicable in vessels with various degrees of autonomy. Manned vessels with sensor fusion-based situational awareness systems can benefit from reliable local information as an advisory feature, whereas automated and autonomous vessels require reliable and precise information on local objects for safe navigation without human intervention.

There are thousands of harbors, seaports, and inland ports in the world. It is not cost-efficient for all vessel operators to collect datasets for machine learning model training from all local environments their vessels might visit. On the other side, the more data is collected and the more location-specific machine learning models are trained and installed on-board, the more data storage of vessel is required. This represents an inconvenience for the owner of the vessel.

Furthermore, a vessel operator may not even have access to all relevant data needed to fully utilize such training data in local port or harbor environments. For example, for accurate location estimation, it is beneficial for the vessel to have both the capability to identify specific navigation reference features and information on the precise locations of such features (e.g. current 3D maps of the port or harbor area including the locations of all visual navigation markers).

The drawback of the current state of the art is that the known solutions do not enable to get sufficient training data for harbors and distribute trained models. Furthermore, the known solutions do not enable to erase the distributed model when it is not needed any more nor to teach the system related to a vessel to learn a way to arrive to all harbors in the world. The amount of data is not sufficient for the training system.

Therefore, in light of the foregoing discussion, there exists a need to overcome the aforementioned drawbacks of training the machine learning location-specific temporary models of vessels for controlling, navigation, path planning, location estimation of vessels.

### SUMMARY

The aim of the present disclosure is to provide a method for transferring a location-specific machine learning model from a harbor operating system to an on-board processing system of a vessel in order to reduce the data volume in the data storage of the vessel and to reduce the use of communication resources of the vessel, when the vessel after leaving the harbor area does not use or does not need the harbor specific dataset anymore. In this context, the vessel is an autonomous vessel (e.g., a ship, a boat, a yacht, a ferry or any other watercraft), a human on-board vessel or a vessel navigated by a human remote operator in a harbor, in a port or in another land-based control center.

In one aspect, an embodiment of the present disclosure provides a method for providing a temporary location-specific machine learning model from a harbor operating system to an on-board processing system of a vessel for assisting the vessel to navigate from an offshore area to dock in a harbor and from the harbor to the offshore area, wherein the temporary location-specific machine learning model is trained by collecting, analyzing and combining datasets of historically collected data of one or more vessels, datasets of external sensors of the vessels, datasets of harbor related information, the method comprising steps of predetermining a geographical area of an area of a harbor for keeping the temporary location-specific machine learning model activated during a time the vessel is in the predetermined geographical area; creating communication by communication means between the harbor operating system and the on-board processing system of the vessel; receiving a specification of the vessel from the on-board processing system of the vessel, at the harbor operating system, wherein the specification of the vessel comprises at least one of an identification of the vessel, an information about sensoring capabilities of the vessel, an information about computational and data processing capabilities of the vessel, an information about software environment of the vessel; receiving a request for the temporary location-specific machine learning model from the on-board processing system of the vessel, at the harbor operating system; preparing at least one software container according to the received specification of the vessel, wherein the at least one software container comprises the temporary location-specific machine learning model; providing the at least one prepared software container comprising at least one of a license key, a digital rights management method, limited subscription time, coordinates of a limited location based on the predetermined geographical area for temporary activation and deactivation the software container and an activation means of the at least one software container from the harbor operating system to the on-board processing system of the vessel; after providing, activating the at least one software container received by the on-board processing system of the vessel by using the provided software container activation means for providing data to the on-board processing system of the vessel for controlling at least one of a navigation of the vessel, course, path planning, identification of a surrounding object types, location estimation and obtaining a heading data of the vessel in the predetermined geographical area of the area of the harbor.

In another aspect, an embodiment of the present disclosure provides a system for providing a temporary location-specific machine learning model from a harbor operating system to an on-board processing system of a vessel for assisting the vessel to navigate between multiple harbors, from an offshore area to dock in a harbor and from the harbor to the offshore area, wherein the temporary location-specific machine learning model is trained by collecting, analyzing and combining datasets of historically collected data of vessels, datasets of external sensors of the vessels, datasets of harbor related information, the system comprising a communication means; at least one server connectable to the harbor operating system; wherein the server comprises the harbor operating system adapted to communicate through the communication means with at least one vessel, the at least one vessel comprising at least one computing means, a sensor system and the on-board processing system; the temporary location-specific machine learning model; wherein the server is configured to store information defining predetermined geographical area for keeping the temporary location-specific machine learning model activated during the time the vessel is in the predetermined geographical area; to receive a request for the temporary location-specific machine learning model from the on-board processing system of the vessel; to prepare at least one software container comprising the temporary location-specific machine learning model; to receive the specification of the vessel via the automatic identification system wherein the specification of the vessel comprises at least one of an identification of the vessel, an information about the sensoring capabilities of the vessel, an information about the computational and data processing capabilities of the vessel, an information about the software environment of the vessel; to provide the at least one software container and an activation means of the at least one software container to the on-board processing system of the vessel via the communication means; and the on-board processing system is configured to activate the at least one software container received by the on-board processing system of the vessel by using the at least one provided software container activation means to provide data to the on-board processing system of the vessel for controlling at least one of the vessel's navigation, course, path planning, identification of the surrounding object types, location estimation and obtaining or identifying heading data of the vessel in the predetermined geographical area of the area of the harbor.

There are thousands of harbors, seaports, and inland ports in the world. It is not cost-efficient for all vessel operators to collect datasets for machine learning model training from all local environments their vessels might visit. The more data is collected and the more location-specific machine learning models are trained and installed on-board, the more data storage of vessel is required.

The technical effect of the features according to the present disclosure are that the features enable efficient and cost-effective data collecting from sensors of vessels and harbor areas, enable to reduce data storage required in the vessels, and enable train and re-train the temporary location-specific machine learning models to be provided to the on-board processing system of the vessels in order to assist navigation of the vessels between multiple harbors, from an offshore area to dock in a harbor and from the harbor to the offshore area enhance navigation capabilities and reliability of the vessel. Thus the features enable to reduce the data volume in the data storage of the vessel and to reduce the use of communication resources of the vessel, when the vessel after leaving the harbor area does not use or does not need the harbor specific dataset anymore.

The software container is configured to assist the vessel at navigation based on temporary location-specific machine learning model parameters for sailing in the predetermined area.

The features enable to solve the technical problem how to reduce amount of data to be stored in the in the on-board processing system of the vessel.

The specification used to prepare the software container enables to avoid sending unnecessary information in the software package to reduce communication capacity and memory needs of the on-board processing system. The benefit of running the temporary location-specific machine learning model only after confirming is to avoid usage of the model outside of the predetermined area, thus to reduce amount of data to be stored in the on-board processing system of the vessel. The activation and deactivation means of the software container enable to provide temporary location-specific machine learning models within the predetermined geographical area. This reduces the amount of data about different harbors and harbor areas that the vessel needs to store in its on-board processing system, when the vessels visit different harbors. Using temporary location-specific machine learning models for a specific geographical area instead of all permanently stored models on-board, which are customized for different harbors, helps in turn to reduce the costs for vessel operators.

By providing temporary models as disclosed in embodiments of present disclosure for use in a specific geographical area instead of permanently storing all models customized for different ports of call, the on-board storage and model management requirements such as version control, updates, and validation, can be reduced. Location-specific machine learning models are provided to or removed from the vessel via remote access to reduce the use of communication resources and data volume of data storage of the vessel. The software container comprising at least one location-specific machine learning model is provided to the vessel via a transmitter installed at a navigation station at sea. This way for example the navigation station such as a seamark, light house etc. can be used as a base station to provide information to the vessel. This is beneficial as it reduces the load on the communication means close to the harbor area.

### BRIEF DESCRIPTION OF THE DRAWINGS

Embodiments of the present disclosure will now be described, by way of example only, with reference to the following diagrams wherein:

FIG. 1 is a schematic illustration of a system according to an embodiment of the present disclosure;

FIG. 2 is a is a block scheme of a method according to an embodiment of the present disclosure and

FIG. 3 is a schematic illustration of a system according to an embodiment of the present disclosure.

### DETAILED DESCRIPTION OF EMBODIMENTS

The following detailed description illustrates embodiments of the present disclosure and ways in which they can be implemented.

In one aspect, an embodiment of the present disclosure provides a method for providing a temporary location-specific machine learning model from a harbor operating system to an on-board processing system of a vessel for assisting the vessel to navigate between multiple harbors, from an offshore area to dock in a harbor and from the harbor to the offshore area, wherein the temporary location-specific machine learning model is trained by collecting, analyzing and combining datasets of historically collected data of the vessels, datasets of external sensors of the vessels, datasets of harbor related information. The method comprises steps of predetermining a geographical area of an area of a harbor for keeping the temporary location-specific machine learning model activated during the time the vessel is in the predetermined geographical area; creating communication by communication means between the harbor operating system and the on-board processing system of the vessel; receiving a specification of the vessel from the on-board processing system of the vessel, at the harbor operating system, wherein the specification of the vessel comprises at least one of an identification of the vessel, an information about the sensoring capabilities of the vessel, an information about the computational and data processing capabilities of the vessel, an information about the software environment of the vessel; receiving a request for the temporary location-specific machine learning model from the on-board processing system of the vessel, at the harbor operating system; preparing at least one software container according to the received specification of the vessel, wherein the at least one software container comprises the temporary location-specific machine learning model; providing the at least one prepared software container comprising at least one of a license key, a digital rights management method, limited subscription time, coordinates of the limited location based on the predetermined geographical area for temporary activation and deactivation the software container and an activation means of the at least one software container from the harbor operating system to the on-board processing system of the vessel; after providing, activating the at least one software container received by the on-board processing system of the vessel by using the provided software container activation means for providing data to the on-board processing system of the vessel for controlling at least one of the vessel's navigation, course, path planning, identification of the surrounding object types, location estimation and obtaining or identifying heading data of the vessel in the predetermined geographical area of the area of the harbor.

Embodiments of the present disclosure eliminate the aforementioned problems in the prior art, and enable efficient and cost-effective data collecting from sensors of vessels and harbor areas, enable to reduce data storage required in the vessels, and provide training and re-training of the location-specific machine learning models to be provided to the on-board processing system of the vessels in order to provide navigation assistance for the vessels in the harbor areas. In the present description, embodiments and variants disclosed in connection with the method apply mutatis mutandis to the system and vice versa.

Indeed, by providing temporary models as disclosed in embodiments of present disclosure for use in a specific geographical area instead of permanently storing all models customized for different ports of call, the on-board storage and model management requirements such as version control, updates, and validation, can be reduced.

After activation of the provided at least one software container, the vessel runs the location-specific machine learning model of the software container as a part of the on-board processing system of the vessel. The software container is deactivated after the expiration of the license of the at least one location-specific machine learning model, optionally also removed from the processing system of the vessel.

An advantage of the present disclosure is that the location-specific models transferred to the vessel enable on-board processing system of the vessel for example to analyze the sensor data better in a contained environment. The location-specific machine learning module can for example contain image analysis package particularly suitable for recognizing objects within the predetermined area. As an example, there might be variations on sea mark designs around the globe. Thus, the resulting information provides additional assistance for the vessels for navigation between multiple harbors, from an offshore area to dock in a harbor and from the harbor to the offshore area. Indeed, the provided location-specific machine learning model can be used to enhance navigation capabilities and reliability of the vessel, wherein the software container is configured to assist the vessel at navigation based on location-specific machine learning model parameters for sailing in the predetermined area.

According to an additional embodiment, the method provides that the location-specific machine learning model of activated software container is activated/taken in use, when the vessel enters to the predetermined geographical area and provides means to keep the location-specific machine learning model activated/in use during the time the vessel is in the predetermined geographical area. Furthermore, a method provides means to deactivate or to deactivate and remove the software container, when the corresponding vessel has left the predetermined geographical area. Furthermore, the software container may be activated temporarily when the corresponding vessel has entered the predetermined geographical area of the harbor.

In another aspect, the present disclosure provides a system and method to gather cost-effectively sufficient training data for location-specific machine learning models for use in an on-board processing system of vessel, e.g. for vessel navigation, path planning, identification of the surrounding object types, location estimation, and/or obtaining and identifying heading data of the vessel at harbor's area. The training data comprises information on the vessel's surroundings based on data from sensors such as cameras, lidars, radars and metadata comprising 3D map information of the harbor area, information of identified landmarks for use in operating (such as navigating, steering).

The cost-effective collecting of training data for location-specific machine learning models of vessels is achieved by collecting the training data by crowdsourcing. I.e. by using the data collected from plurality of vessels arriving to plurality of harbors and other reference information for training the location-specific machine learning models and then sharing the location-specific machine learning models with the vessels arriving to the harbors, wherein the location-specific machine learning model has an expiration period. Alternatively, those are provided to or removed from the vessel via remote access to reduce the use of communication resources and data volume of data storage of the vessel.

To achieve the aim of the present disclosure the training data sets and other reference information such as metadata comprising 3D map information of the harbor area, information of identified landmarks has been compiled. Based on the compiled training datasets and reference information, the location-specific machine learning models have been trained and verified. The trained and verified location-specific machine learning models, together with reference information on the trained objects has been provided according to the present disclosure to the vessels for assisting the navigation of the vessel in the harbor area.

As a vessel enters to a predetermined area of the harbor, the relevant location-specific machine learning model or models, depending on the sensors and computational capabilities of the vessel, are transferred to the vessel via a wireless connection or a physical agent such as a drone. When the vessel leaves the harbor area, the location-specific machine learning models transferred to the vessel is disabled or removed from the systems of vessels by using digital rights management methods.

The location-specific machine learning model refers to a computer model which can be used to analyze sensor data, make navigation proposals or decisions in given location area. The model is called location-specific as it takes into account location specific characteristics and it has been trained using training data related to the location of the area. The harbor operating system is a system configured to control and help operations of a harbor area (including shore and sea area in proximity of the harbor). The on-board processing system is a computing system of a vessel.

The predetermined area can refer to an area surrounded by longitude and latitude co-ordinates. Alternatively, it can correspond to an area determined by a distance from the harbor. It can be for example an area starting from a certain point of a route to the harbor and cover the route of a certain width. The created communication between the harbor operating system and the on-board processing system of the vessel can be arranged using secured radio communication. The communication can be arranged for example using cellular connectivity, satellite communication, VHF data communication etc.

The harbor operating system is arranged to receive a specification (using for example the communication channel) of the vessel from the on-board processing system of the vessel. The specification of the vessel can be for example a vessel model, an amount of cargo, a list of sensors in the vessel, engine characteristics, a model of the vessel or a type of the on-board processing system and version information of a software running in the on-board processing system. This specification is used to prepare at least one software container according to the received specification of the vessel. The specification of the vessel is taken in account during the preparation to avoid sending unnecessary information in the software package (to reduce communication capacity and memory needs of the on-board processing system). For example, memory constrains, operating system of on-board processing system, data limitations etc. are taken into account. Further for example if the vessel has a certain type of sensor such as a high resolution camera, the preparation of the software container can take into account the sensor and provide a location-specific machine learning model customized for said camera type to be used in the predetermined area. The preparation might be optionally carried out only for the vessel which has been confirmed to have entered into the predetermined geographical area of the harbor. The confirmation can be done using the same or a separate communication channel. The confirmation can be done for example through a second, i.e., separate, channel such as for example VHF-based AIS radio messages received from the vessel.

The prepared at least one software container comprises the location-specific machine learning model. As discussed, the model takes into account the vessel specification. For example, the model can take into account that the approaching vessel has a first set of sensors such as cameras installed on the deck. It might take into account engine type (thruster model, propulsions system characteristics) as well as computing capabilities of the on-board processing (computing) system. The model can take into account currents in the harbor area, tide, effect of wind speed. The software container can comprise more than one location-specific machine learning model. There can be for example different location-specific machine learning models for each different sensor type of the vessel (the sensor types as indicated by the specification) or steering systems of the vessels (as indicated by the specification).

The prepared at least one software container is provided to the on-board processing system of the vessel. The at least one software container is provided together with activation means. The activation means are for example license keys to activate the software container or a part of it. For example, the location-specific machine learning model can be decrypted using the activation means. Those can be provided using the created communication means. The provided software container is activated by the activation means.

According to an embodiment, the specification of the vessel comprises at least one of an identification of the vessel, an information about the sensoring capabilities of the vessel, an information about the computational and data processing capabilities of the vessel, an information about the software environment of the vessel.

According to an additional embodiment, the location-specific machine learning model of the software container is decrypted and then installed as plug-in component to on-board processing system. The plug-in component can be then used to help to navigate the vessel to and from the harbor. The component can be used to help the vessels' own navigation (and possible machine learning system) to for example identify objects in the harbor area. The component can be in an example used to automatically navigate the vessel to and from the harbor. I.e. after activation of the provided at least one software container, the vessel runs the location-specific machine learning model of the software container as a part of the on-board processing system of the vessel. The software container is deactivated after the expiration of the license of the at least one location-specific machine learning model.

According to an embodiment, the method further comprises confirming that the vessel has entered to the predetermined geographical area of the harbor. This can be done by receiving for example an Automatic Identification System (AIS) message from the vessel. The message can comprise location and ID (identification) of the vessel. The location information is used to check if the vessel has entered the predetermined area. Combination of the location information and predetermined area can be referred as geofencing means. Provided that the confirmation is positive, the provided at least one location-specific machine learning model of the at least one software container is run as a part of the on-board processing system of the vessel. The benefit of running the location-specific machine learning model only after confirming is to avoid usage of the model outside of the predetermined area. For example, some of the models might not work properly outside of the area, thus risking vessel and life of persons in the vessel.

According to another embodiment, the method further comprises receiving the request for continuation of the license from the on-board processing system of the vessel by the harbor operating system; confirming that the vessel is in the predetermined geographical area, checking model versions and updating the location-specific models and containers by the harbor operating system; transmitting the updated container with updated location-specific models to the vessel and an updated activation and deactivation means of the software container from the harbor operating system to the on-board processing system of the vessel; updating and running the provided updated location-specific machine learning model of the updated container as part of the on-board processing system of the vessel; and deactivating the updated location-specific machine learning model.

According to an embodiment, the specification of the vessel comprises transmitting at least one of an ID (identification) of the vessel, information about the capabilities of the sensoring system of the vessel, information about the computational and data processing capabilities of the vessel or information about the software environment of the vessel. The detailed information about capabilities of the vessel enables to select appropriate location-specific machine learning model and prepare corresponding software containers, which are suitable for the vessel which requests the location-specific machine learning models.

According to another embodiment, the activation means of the software container is at least one of a license key, a digital rights management method, limited subscription time, coordinates of the limited location based on the predetermined geographical area for temporary activation and deactivation the software container, or a combination thereof. As an example, the activation means provide instructions to de-install the provided software container (or parts of it such as the location-specific machine learning model) as soon as the vessel has exited from the predetermined area. The activation means work also effectively as deactivation means since for example when the subscription time of the activation means is run out, it logically becomes deactivation means.

In yet another embodiment, deactivating the location-specific machine learning model is performed automatically based on at least one of time limits, location limits, expiration of the license, digital rights management method, or combinations thereof.

The activation and deactivation means of the software container enable to provide temporary location-specific machine learning models within the predetermined geographical area. This reduces the amount of data about different harbors and harbor areas that the vessel needs to store in its on-board processing system(s), when the vessels visit different harbors. Using temporary location-specific machine learning models for a specific geographical area instead of all permanently stored models on-board, which are customized for different harbors, helps in turn to reduce the costs for vessel operators.

The term “harbor” used herein throughout the present disclosure refers to man-made or natural sea or inland ports, mooring place, anchorages, piers, or other commercial facilities used for vessels and their cargo. The harbor may be equipped with customs, transport systems and connections to rail and road networks, warehouses, docks, repair shops, hotels, loading equipment, recreational facilities or other buildings and infrastructure facilities for cargo, passenger, sport and another type of vessels.

The harbor, according to the present description, is equipped with a harbor operating system, which enables the communication between the harbor and vessel to carry out the present method.

In another aspect, an embodiment of the present disclosure provides a system for providing a temporary location-specific machine learning model from a harbor operating system to an on-board processing system of a vessel for assisting the vessel to navigate between multiple harbors, from an offshore area to dock in a harbor and from the harbor to the offshore area, wherein the temporary location-specific machine learning model is trained by collecting, analyzing and combining datasets of historically collected data of vessels, datasets of external sensors of the vessels, datasets of harbor related information, the system comprising a communication means; at least one server connectable to the harbor operating system; wherein the server comprises the harbor operating system adapted to communicate through the communication means with at least one vessel, the at least one vessel comprising at least one computing means, a sensor system and the on-board processing system; the temporary location-specific machine learning model; wherein the server is configured to store information defining predetermined geographical area for keeping the temporary location-specific machine learning model activated during the time the vessel is in the predetermined geographical area; to receive a request for the temporary location-specific machine learning model from the on-board processing system of the vessel; to prepare at least one software container comprising the temporary location-specific machine learning model; to receive the specification of the vessel via the automatic identification system wherein the specification of the vessel comprises at least one of an identification of the vessel, an information about the sensoring capabilities of the vessel, an information about the computational and data processing capabilities of the vessel, an information about the software environment of the vessel; to provide the at least one software container and an activation means of the at least one software container to the on-board processing system of the vessel via the communication means; and the on-board processing system is configured to activate the at least one software container received by the on-board processing system of the vessel by using the at least one provided software container activation means to provide data to the on-board processing system of the vessel for controlling at least one of the vessel's navigation, course, path planning, identification of the surrounding object types, location estimation and obtaining or identifying heading data of the vessel in the predetermined geographical area of the area of the harbor.

Optionally, the harbor operating system may comprise a harbor data collecting means configured to collect raw data from sensor systems, for example day cameras, night cameras, lidars, radars, sonars and/or microphones, etc.; a data annotation means configured to annotate the collected raw data for example by object locations, object classifications, object trajectories, segmentation events and/or semantic analysis; means configured to prepare training examples; a location-specific machine learning model training means configured to carry out the machine learning training, for example by model architecture selection, transfer learning, gradient descent and/or hyperparameter tuning; a testing means configured to test the location-specific machine learning models, for example by testing training loss, validation loss, test set metrics and/or cross validation; a deployment means configured to carry out the software deployment of tested models, wherein the deployment comprises optimization for inference, mapping to runtime libraries, packaging to software containers and/or generation of license keys; a communication means configured to verify a type, an identity and/or a location of a vessel, or to transmit software containers and/or tp transmit license information; an identification system (e.g. VHF radio-based Automatic Identification System (AIS)) to predetermine a geographical area of the harbor and/or to confirm, from a separate channel, that the vessel approaching to the harbor is in the predetermined geographical area (e.g. from VHF-based AIS radio messages received from the vessel), arriving to the predetermined geographical area and/or leaving the predetermined geographical area.

In the present disclosure, the training and re-training of location-specific machine learning models is carried out based on use of for example neural networks. The neural network of the location-specific machine learning model is trained by collecting, analyzing and combining datasets of historically collected data of vessels; external sensors of the vessels; information related to harbor infrastructure and/or another harbor related information.

Optionally, the on-board processing system of a vessel may comprise a vessel data collecting means configured to collect data from the sensors (e.g., day cameras, night cameras, lidar, radar, sonar, microphones, etc.) of the vessel; a signal processing means configured to collect the raw data from the vessel data collecting means (e.g., data registration, filtering, sampling, conversions, noise removal, location-specific machine learning model inference, etc.) and transfer the processed data to semantic data and spatial data; a sensor fusion system configured to perform for example object tracking, statistical signal processing, bayesian filtering, data fusion, trajectory prediction, etc.; a situational awareness information system configured to increase safety; and/or a control system configured to perform collision prediction, path planning, propulsion and steering control, etc.

Optionally, the sensoring system of the vessel may comprise for example a camera system for monitoring vessel surroundings; existing machine learning models of the vessel; thermal and visible light camera systems, lidar, radar, sonar, microphone systems, inertial navigation systems, etc.

Optionally, the existing machine learning models of the vessel and/or the software container comprising the location-specific machine learning models to be provided to the vessels comprise at least one model selected from a group of a model for detection and classification of vessel types and seamarks; a detection and classification model for detecting and classifying vessels in the area of the harbor with minimized false positive detections (such as from harbor structures and other fixed objects); a model for automatically detecting, identifying and classifying landmarks and relevant features for navigation of the area of the harbor (such as specific berths, terminals, cranes, etc.); a model for object detection and classification from camera systems and 3D lidar point cloud data; a radar and sonar clustering model; an audio detection and classification model.

In different alternative embodiments, the local-specific model of the software container comprises at least one of detection and classification models optimized for detecting and classifying typical vessels in the local area with minimized false positive detections from harbor structures and other fixed objects; models for automatically detecting, identifying and classifying landmarks and relevant local features for navigation such as specific berths, terminals, cranes, etc.; general models for object detection and classification from camera systems and 3D lidar point cloud data; radar and sonar clustering models; audio detection and classification models; locally optimized and customized versions of the existing models, with added capabilities of identifying local features relevant for the navigation and local models provided for predicting vessel trajectories in the area to assist the autonomous navigation system.

The vessel may provide its ID through the secure main direct communication channel between the vessel and harbor, and the harbor may then confirm, through a separate system such as locally received VHF (very high frequency)-band AIS (automatic identification system), messages that this vessel is in the predetermined geographical area, and then provide a license which is valid for a limited time. This ensures that the location-specific machine learning models are used only in the correct environment and that the location-specific machine learning models are up to date.

According to an embodiment, wherein the vessel is equipped with simple sensoring and limited situational awareness system for increasing safety, the vessel has a human pilot on-board, the sensoring system of the vessel comprises for example a camera system for monitoring vessel surroundings and the existing machine learning models of the vessel comprise models for detection and classification of common vessel types and seamarks. Based on the information received from camera data of the vessel, the software container created and provided to the vessel according to the present embodiment comprises local-specific models comprising detection and classification models optimized for detecting and classifying typical vessels in the local area with minimized false positive detections from harbor structures and other fixed objects; and models for automatically detecting, identifying and classifying landmarks and relevant local features for navigation such as specific berths, terminals, cranes, etc.

According to another embodiment, wherein the vessel has remote pilotage capability and is equipped with a sensor system to enable full sensor fusion-based situational awareness, the sensor system of the vessel comprises for example thermal and visible light camera systems, lidar, radar, sonar, microphone systems, inertial navigation systems, etc. and the existing machine learning models of the vessel comprises general models for object detection and classification from camera systems and 3D lidar point cloud data, radar and sonar clustering models, audio detection and classification models.

Based on the information received from such existing machine learning models of the vessel, the software container created and provided to the vessel according to this embodiment comprises local-specific models comprising locally optimized and customized versions of the existing models, with added capabilities of identifying local features relevant for the navigation.

In a third embodiment, wherein the vessel has autonomous navigation capabilities, the vessel is equipped with a sensor system to enable full sensor fusion-based situational awareness, and the sensor system of the vessel comprises for example thermal and visible light camera systems, lidar, radar, sonar, microphone systems, inertial navigation systems, etc. and the existing machine learning models of the vessel comprises general models for object detection and classification from camera systems and 3D lidar point cloud data; radar and sonar clustering models; audio detection and classification models.

Based on the information received from such existing machine learning models of the vessel the software container created and provided to the vessel according to this third embodiment comprises local-specific models comprising locally optimized and customized versions of the existing models, with added capabilities of identifying local features relevant for the navigation and local models provided for predicting vessel trajectories in the area to assist the autonomous navigation system.

Regarding the software environment of the vessel and processing capabilities of the vessel for the cases above, the software environment of the vessel is an implementation detail (e.g., host operating system selection), which is not directly tied to the use case. The HW computational capabilities of the vessel are preferably scalable with respect to the added sensors and related signal processing, meaning e.g., scaling in number and processing capacity of processors, amount of memory and storage capacity, internal network bandwidth, and computational capability of machine learning acceleration devices such as Graphical Processing Units (GPUs).

In another alternative embodiment, the sensor data for model training is optionally provided from the on-board processing system of the vessel to the harbor operating system. This enables to reduce the service costs and supports the machine learning process of the location-specific models. The provided sensor data is received from the on-board processing system of the vessel and reviewed, annotated and added to the training or test data sets by the harbor operating system.

In an embodiment, the prepared software container comprises at least one location-specific machine learning model for detecting objects of interest, selected from a group consisting of at least one of a visible light camera, a thermal camera, a lidar, a radar, a sonar.

In an embodiment, the prepared software container comprises at least one location-specific machine learning model for optimization the navigation for dynamically and automatically adjusting the sailing plan of the vessel, so that the sailing plan, considering the route and speed based on sensor data and mission of the vessel and changing circumstances, is the most optimal. The location-specific machine learning model for the optimization is trained for example with historical vessel traffic data collected from the predetermined geographical area.

In an embodiment, the prepared software container comprises at least one location-specific machine learning model for navigational purposes and a training data collector module for optimization of (future and current versions of) location-specific machine learning model. The training data collector module may be configured to collect vessel traffic data from at least one vessel sailing in harbors and to provide the collected data to the harbor operating system for further training of at least one location-specific machine learning model. The training module provided to the vessel helps to collect training data to be used when training location-specific machine learning models. In one embodiment, the training data collector module is kept activated also outside of the predetermined area to collect information from other areas. The collected information can be used to train location-specific machine learning modules to said other areas (such as other harbors) to be used in those areas.

In an embodiment, the specification of the vessel comprises at least one of data of navigational status, draught, length, destination, sensor systems, sensoring capabilities, computational capacity, computational capabilities and availability of location-specific machine learning models for the area of the harbor.

In an embodiment, the activated software container is further configured to provide data to the on-board processing system of the vessel for controlling at least one of the vessel's navigation, course, path planning, identification of the surrounding object types, location estimation and obtaining or identifying heading data of the vessel.

In an embodiment, the communication means is radio frequency, satellite connection, mobile roaming or other wireless communication means. The system may also comprise means for collecting datasets for continuous training of the location-specific machine learning models. In another embodiment, the server is configured to store and combine the data of the predetermined geographical area with the dataset of harbor's infrastructure, information related to the harbor area, navigation markers, landmarks and map data.

According to an embodiment, the prepared software container further comprises a training data collector module for optimization of the location-specific machine learning model

In an embodiment, the software container further comprises a digital rights management application configured to execute an activation or a deactivation of the software container, which is initiated via the predetermined geographical area controlled by the automatic identification system. Alternatively, the digital rights management application is configured to execute a deactivation and removal of the software container.

In an embodiment, the deactivation of the software container is performed by a limited subscription time or a temporary license key controlled and provided by the server.

In an embodiment, the software container comprising at least one location-specific machine learning model is provided to the vessel via a transmitter installed at a navigation station at sea. This way for example the navigation station such as a seamark, light house etc. can be used as a base station to provide information to the vessel. This is beneficial as it reduces the load on the communication means close to the harbor area (as part of the communication takes place at a proximity of the navigation station).

In another embodiment, the software container comprising at least one location-specific machine learning model is transmitted to the vessel via communication means located at the shore. It is also possible to use both ways to transmittal.

According to an alternative or additional embodiment, the method further comprises enabling (for example by navigation assistance) continuously collecting datasets from multiple data sources for continuous training of at least one location-specific machine learning model, initiating the activated software container to assist the on-board processing system of the vessel at navigation by the location-specific machine learning model of activated software container within the predetermined geographical area; and deactivating the software container when the vessel has departed the predetermined geographical area by disabling or disabling and removing the software container from the on-board processing system of the vessel.

The datasets can be for example types of the vessels, their typical routes and schedules, data of navigational status, draught, length, destination, sensor systems, sensoring capabilities, computational capacity, computational capabilities, and availability of location-specific machine learning models for the target harbor; datasets of harbor's infrastructure and other information related to harbor area (e.g. buildings, piers, cranes, bridges), navigation markers, landmarks and map information of the harbor area. The data sources can be for example different vessels or different harbor areas. The system is further configured to predetermine a geographical area of a harbor area by a geofencing means and storing information of the predetermined area in a server. The predetermination of the geographical area of the harbor area is carried out by creating a virtual geographic boundary in the system by GPS, mobile application and/or map coordinates. According to an embodiment, the activated software container is initiated to assist the on-board processing system of the vessel at navigation by the location-specific machine learning model of activated software container within the predetermined geographical area. Further, the software container is deactivated when the vessel has departed the predetermined geographical area by disabling or disabling and removing the software container from the on-board processing system of the vessel.

Further, the system receives data of system capabilities of at least one vessel (for example navigational status, draught, length, destination, sensor systems, sensoring capabilities, computational capacity, computational capabilities, and availability of location-specific machine learning models for the target harbor) of interest approaching to the predetermined geographical area using an automatic identification system over wireless communication means (for example radio frequencies, satellite connection) and verifies the corresponding vessel.

As the vessel is approaching and/or entering to the predetermined geographical area of the harbor area, the vessel is verified via automatic identification system connected to the server of the system, and the system is further configured to prepare, by generating and configuring, at least one container comprising at least one location-specific machine learning model applicable in the corresponding vessel depending on the received specification of that vessel.

The prepared software container is transferred from the server of the system to on-board processing system of the corresponding vessel by communication means. For example, the prepared software container comprising at least one location-specific machine learning model is transmitted to the vessel via a transmitter installed at a navigation station at sea or via communication means at the shore.

In an alternative embodiment, the prepared software container comprises at least one of at least one location-specific machine learning model for detecting objects of interest, selected from a group consisting of at least one of a visible light camera, a thermal camera, a lidar, a radar, a sonar; a location-specific machine learning model for optimization of the navigation for dynamically and automatically adjusting the sailing plan of the vessel, so that the sailing plan, considering the route and speed, based on sensor data and mission of the vessel and changing circumstances in the harbor area and/or configuration of vessel is the most optimal; at least one location-specific machine learning model for navigational purposes and a location-specific machine learning model for optimization of the navigation.

In an embodiment, wherein the software container comprises multiple location-specific machine learning models, the location-specific machine learning models are configured to operate concurrently as independent applications.

In an alternative embodiment, the software container comprises digital rights management application configured to execute an activation or a deactivation of the software container, when the software container is transferred to the vessel by the automatic identification system, when the vessel enters to or leaves the predetermined geographical area. In an embodiment, the deactivation of the software container is performed by a limited subscription time (e.g. time after leaving the predetermined geographical area) or a temporary license key controlled and provided by the server.

In addition to automatically collected training datasets, in an alternative embodiment, the location-specific machine learning model for navigation and/or the location-specific machine learning model for optimization is trained with historical vessel traffic data collected from the harbor area.

The system is further configured to activate the prepared software container transferred to the vessel temporarily in a limited geographical area or for a limited time, when the vessel has entered into the predetermined geographical area and to initiate the activated software container to assist the on-board processing system of the vessel at navigation by a location-specific machine learning model of activated software container within the predetermined geographical area to assist the navigation of the vessel during the sailing in the predetermined area, to dock in the harbor area and leaving the harbor area.

Once the vessel is ready to leave the predetermined geographical area of the harbor area, the system is configured to deactivate or to deactivate and remove the software container, which is carried out, for example by a digital rights management method.

In an alternative embodiment, when the vessel visits the corresponding predetermined geographical area frequently, the system is configured not to remove the software containers, in which case the system does not deliver these containers wirelessly to the vessel again at its next visit. If the software containers are activated based on geographical location, the system activates the software containers automatically on the next visit of the vessel. Otherwise, a temporary license key is provided by the system to activate existing machine learning models.

In an additional embodiment, the system comprises an automatic identification system connectable to the server. The automatic identification system can be for example AIS system. The system can be used to provide information to the server that a given vessel (for example based on its ID) has entered or left the predetermined area of the harbor. The server is further configured to communicate with the automatic identification system via the communication means and to confirm that the vessel has entered the predetermined geographical area of the harbor using information from the automatic identification system. The on-board processing system is further configured to initiate to assist the on-board processing system of the vessel at navigation by the location-specific machine learning model of the activated software container, when the vessel has entered to the predetermined geographical area, during the time the vessel is in the predetermined geographical area, and to deactivate or to deactivate and remove the software container when the corresponding vessel has left the predetermined geographical area.

In another aspect, an embodiment of the present disclosure provides a system for training on-board processing system of the vessel to assist the navigation of the vessel from the offshore area to dock in the harbor, the system comprises: at least one server comprising existing machine learning models and a location-specific machine learning model; a means configured to collect first training data from different vessels arriving to different harbors for training the existing machine learning models and to collect the training data for training the location-specific machine learning model; a means configured to share the trained existing machine learning model and the trained location-specific machine learning model with at least one vessel.

In another aspect, an embodiment of the present disclosure provides a method of operating the system for training on-board processing system of the vessel, the method comprises steps of: collecting a first training data and training an existing machine learning model of a vessel; collecting a second training data and training location-specific machine learning model to be provided to the vessel; sharing the trained existing machine learning model and the trained location-specific machine learning model with at least one vessel by transferring the trained location-specific machine learning models from the server to the on-board processing system of the vessel. In a still further aspect, an embodiment of the present disclosure provides a method for providing a location-specific machine learning model from a harbor operating system to an on-board processing system of a vessel.

The method further comprises steps of predetermining a geographical area of an area of a harbor; creating a first communication channel between the harbor operating system and the on-board processing system of the vessel; receiving a specification of the vessel from the on-board processing system of the vessel to the harbor operating system; receiving a request for the location-specific machine learning model from the on-board processing system of the vessel, at the harbor operating system; preparing at least one software container according to the received specification of the vessel, wherein the at least one software container comprises at least one location-specific machine learning model; providing the at least one prepared software container with the at least one location-specific machine learning model and an activation means of the software container from the harbor operating system to the on-board processing system of the vessel; after providing, activating the at least one software container received by the on-board processing system of the vessel by using the transmitted container activation means.

In another aspect, an embodiment of the present disclosure provides a system for providing a location-specific machine learning model from a harbor operating system to an on-board processing system of a vessel, the system comprises a communication means; at least one server connectable to an infrastructure of a harbor; an automatic identification system connectable to the server; a geofencing means connectable to the server, and configured to create data of a predetermined geographical area of the harbor; wherein the server comprises the harbor operating system adapted to communicate through the communication means and automatic identification system with at least one vessel, the vessel having at least one computing means, a sensor system and the on-board processing system comprising an existing machine learning model; at least one location-specific machine learning model; wherein the server is configured to communicate with the automatic identification system and the geofencing means via the communication means; to prepare a software container comprising at least one location-specific machine learning model to enhance navigation capability and reliability of the vessel, wherein the software container is configured to assist the vessel at navigation based on location-specific machine learning model parameters for sailing in the predetermined geographical area; to identify a plurality of vessels approaching the predetermined geographical area; to receive data of system capabilities of at least one identified vessel via the automatic identification system; to provide the software container to at least one vessel via the communication means; and the on-board processing system is configured to activate the software container temporarily when the corresponding vessel has entered into the predetermined geographical area; to initiate to assist the on-board processing system of the vessel at navigation by the location-specific machine learning model of activated software container, when the vessel enters to the predetermined geographical area to assist the navigation of the vessel in the harbor area during the time the vessel is in the predetermined geographical area; and to deactivate or to deactivate and remove the software container, when the corresponding vessel has left the predetermined geographical area. Alternatively, the software container can be activated by server by sending relevant instructions to on-board computing system.

In yet another aspect, an embodiment of the present disclosure provides a system for navigation assistance of a vessel to assist the navigation of the vessel between multiple harbors, from an offshore area to dock in a harbor and from the harbor to the offshore area, the system comprising a communication means; at least one server connectable to a harbor operating system; an automatic identification system connectable to the server; a geofencing means connectable to the server, and configured to create data of a predetermined geographical area of the harbor; wherein the server comprises a harbor operating system adapted to communicate through the communication means and automatic identification system with at least one vessel, the vessel having at least one computing means, a sensor system and an on-board processing system comprising an existing machine learning model, at least one location-specific machine learning model; and the server is configured to communicate with the automatic identification system and the geofencing means via the communication means; to prepare by generating and configuring a software container of at least one location-specific machine learning model to enhance navigation capability and reliability of a vessel, wherein the software container is configured to operate the vessel based on location-specific machine learning model parameters for sailing in the predetermined area; to identify a plurality of vessels approaching the predetermined geographical area; to receive data of system capabilities of at least one identified vessel via the automatic identification system; to provide the software container to at least one vessel via the communication means; to activate the software container temporarily when the corresponding vessel has entered into the predetermined geographical area; to initiate to assist the on-board processing system of the vessel at navigation by the location-specific machine learning model of activated software container, when the vessel enters to the predetermined geographical area to assist the navigation of vessel in the harbor area during the time the vessel is in the predetermined geographical area; and to deactivate or to deactivate and remove the software container, when the corresponding vessel has left the predetermined geographical area.

In another aspect, an embodiment of the present disclosure provides a method of operating a system for navigation assistance of a vessel, comprising steps of: continuously collecting datasets from multiple data sources for continuous training of at least one location-specific machine learning model; predetermining a geographical area of a harbor area by a geofencing means and storing information of the predetermined area in a server; receiving data of system capabilities of at least one vessel approaching the predetermined geographical area through a communication means and an automatic identification system; verifying the vessel entered into the predetermined geographical area; generating and configuring at least one container comprising at least one location-specific machine learning model applicable in the vessel depending on the received data of system capabilities of the vessel; providing at least one prepared software container comprising at least one location-specific machine learning model to at least one vessel by transmitting the prepared software container from the server to the vessel via communication means; activating the prepared software container temporarily when the vessel has entered into the predetermined geographical area; initiating the activated software container to assist the on-board processing system of the vessel at navigation by a location-specific machine learning model of activated software container within the predetermined geographical area; and deactivating the software container when the vessel has departed the predetermined geographical area by disabling or disabling and removing the software container from the on-board processing system of the vessel, wherein deactivating the software container is performed by a digital rights management method.

The variants and embodiments disclosed above apply mutatis mutandis to these systems and methods.

### DETAILED DESCRIPTION OF THE DRAWINGS

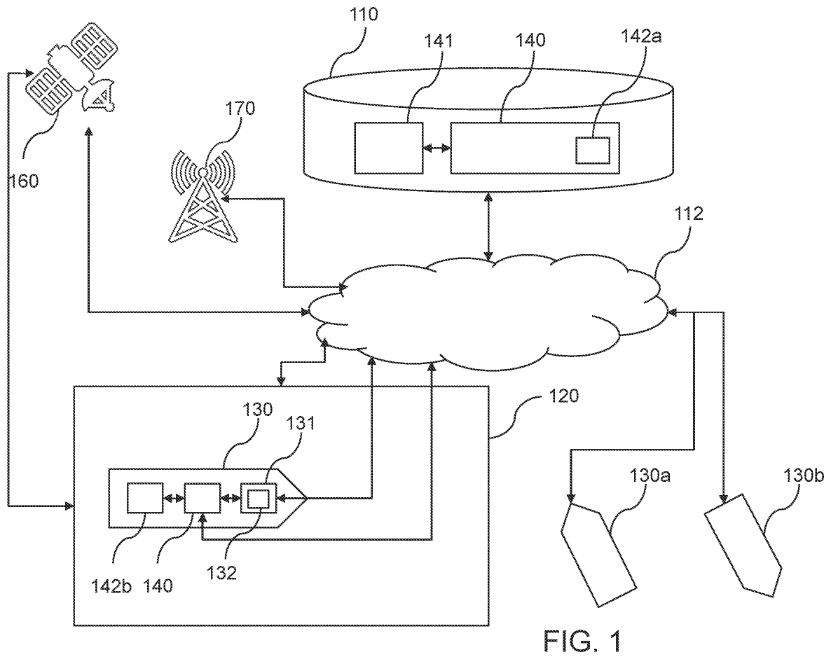

Referring to FIG. 1, there is shown a schematic illustration of an exemplary embodiment of a system according to the present invention. The system comprising a communication means 112; at least one server 110 connectable to an infrastructure of a harbor; an automatic identification system 170 connectable to the server 110; a geofencing means 160 connectable to the server 110, and configured to create data of a predetermined geographical area 120 of the harbor.

The server 110 comprises a harbor operating system 141 adapted to communicate through the communication means 112 and automatic identification system 170 with at least one vessel 130 and at least one location-specific machine learning model 142a, 142b. The vessel having at least one computing means, a sensor system and an on-board processing system 131 comprising an existing machine learning model 132. The server 110 is configured to communicate with the automatic identification system 170 and the geofencing means 160 via the communication means 112, to prepare by generating and configuring a software container 140 of at least one location-specific machine learning model to enhance navigation capability and reliability of a vessel 130.

The software container is configured to operate the vessel based on location-specific machine learning model parameters for sailing in the predetermined geographical area, to identify plurality of vessels approaching the predetermined geographical area, to receive data of system capabilities of at least one identified vessel via the automatic identification system 170, to provide the software container 140 to at least one vessel 130 via the communication means, to activate the software container 140 temporarily when the corresponding vessel 130 has entered into the predetermined geographical area 120, to initiate assist the on-board processing system of the vessel at navigation by the location-specific machine learning model of activated software container 140, when the vessel enters to the predetermined geographical area to assist the navigation of the vessel in the harbor area during the time the vessel is in the predetermined geographical area, and to deactivate or to deactivate and remove the software container 140, when the corresponding vessel has left the predetermined geographical area 120.

Vessels 130, 130a, 130b are sailing on a sea area, wherein vessels 130 having an existing machine learning model has entered into the predetermined geographical area 120 of the harbor area. A location-specific machine learning model 142a is transferred from server 110 via communication means 112 to the on-board processing system 131 of the vessel 130 and activated 142b in the on-board processing system 131, when the vessel 130 has entered to the predetermined geographical area 120. The activated software container comprising location-specific machine learning model 142b is used to assist navigation of the vessel 130 automatically in such a way that it can dock in the harbor. As the vessel 130 exits the predetermined geographical area 120 then the location-specific machine learning model is deactivated in the vessel 130 by disabling and/or removing from the vessel 130. Vessels 130a, 130b outside of the predetermined geographical area 120 use an existing machine learning model 132 purposed for offshore sailing.

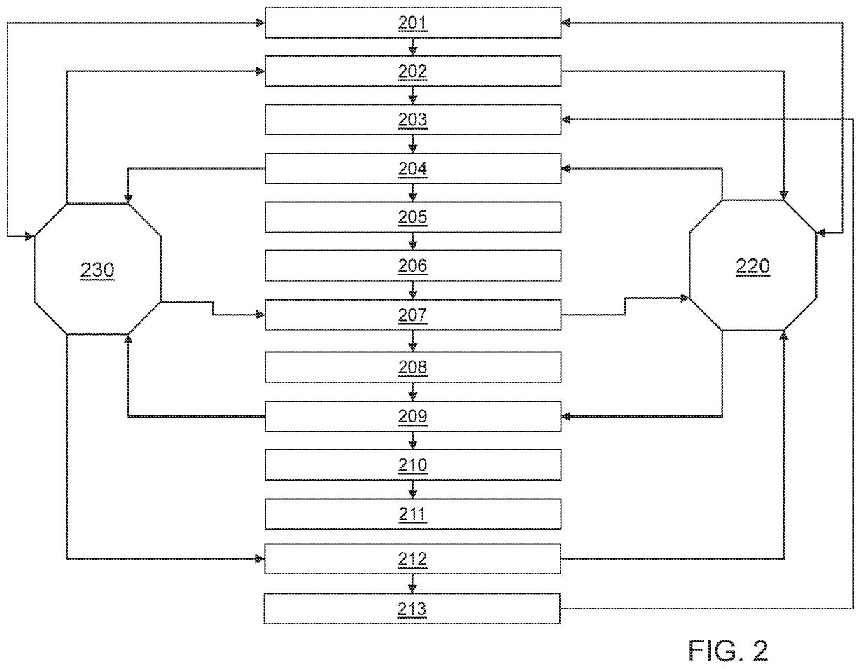

Referring to FIG. 2, there is shown a block scheme of a method according to an embodiment of the present disclosure for transferring a location-specific machine learning model from a harbor operating system 220 to an on-board processing system of a vessel 230 by creating secure communication channel (e.g. cellular with encryption) 201 between the on-board processing system of the vessel 230 and the harbor operating system 220. The specification of the vessel comprising vessel ID (e.g., IMO number), vessel requests machine learning local-specific model service is transmitted 202 from the on-board processing system of the vessel 230 to the harbor operating system 220 and the harbor operating system 220 specifies sensoring capabilities, processing capabilities and software environment of the vessel.

The harbor operating system 220 confirms 203 from the separate channel that the vessel is in the predetermined geographical area (e.g., from VHF-based AIS radio messages received from the vessel), prepares software container according to the specification of the vessel. The harbor operating system 220 transmits 204 at least one software container with at least one applicable location-specific machine learning model and license key or other means of activating the software container to the on-board processing system of the vessel 230. The on-board processing system of the vessel 230 activates 205 the received container using provided license, runs provided models as part of the on-board processing system.

The activated location-specific machine learning model is automatically deactivated 206 when the license expires or deactivated based on time or location limits based on the coordinates of the predetermined geographical area.

Optionally, the vessel may request 207 continuation of license (possibly on later port call) from the harbor operating system 220. The harbor operating system 220 performs the check that the vessel is in the predetermined geographical area the version of the location-specific machine learning model is checked 208. The location-specific machine learning model, if necessary, is updated by the harbor operating system 220.

The updates of the location-specific machine learning model and corresponding license key or other means of activating the software containers are transmitted 209 by the harbor operating system 220 to the on-board system of the vessel 230. The on-board system of the vessel 230 updates and runs 210 provided updated models as part of the on-board processing system 230. The location-specific machine learning model is deactivated 211 based on time or location limits.

Optionally, the on-board processing system of the vessel 230 provides 212 sensor data for location-specific machine learning model training which enables to reduce the service cost. The sensor data provided by the on-board processing system of the vessel 230 is reviewed, annotated and added 213 to the training or test data sets if applicable by the harbor operating system 220.

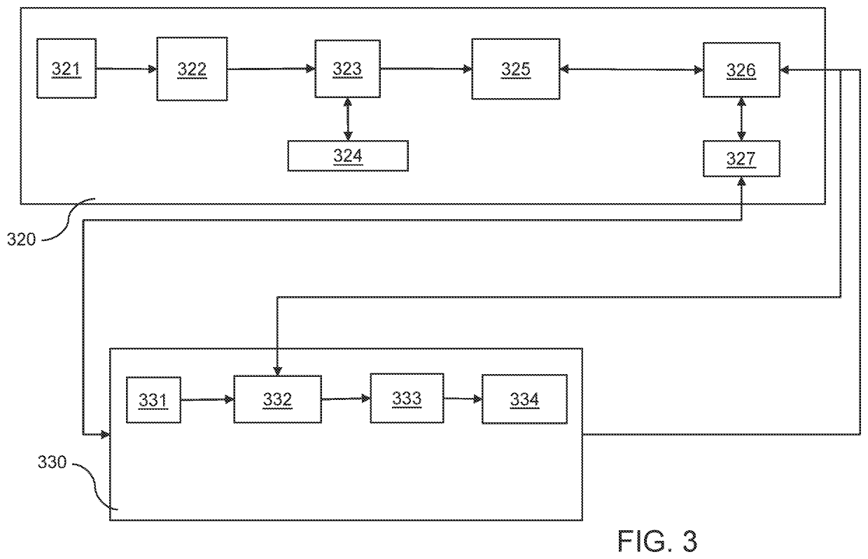

Referring to FIG. 3, there is shown a block scheme of a system according to an embodiment of the present disclosure configured to carry out the method for providing a location-specific machine learning model from a harbor operating system 220 to an on-board processing system of a vessel 330, wherein the harbor operating system 220 comprises a harbor data collecting means 321, a data annotation means 322, a means configured to prepare training examples, a location-specific machine learning model training means 323, a location-specific machine learning model testing means 324, a deployment means 325, a communication means 326, identification system (e.g. VHF radio-based Automatic Identification System (AIS)) 327 and the on-board processing system of a vessel 330 being connectable identification system 327 and via the communication means 326 with the harbor operating system 220 comprises a vessel data collecting means 331, a signal processing means 332, a sensor fusion system configured 333, a situational awareness information system, a control system 334.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Expressions such as “may” and “can” are used to indicate optional features, unless indicated otherwise in the foregoing. Reference to the singular is also to be construed to relate to the plural.

1. A method for providing a temporary location-specific machine learning model from a harbor operating system (141, 220, 320) to an on-board processing system of a vessel for assisting the vessel to navigate from an offshore area to a dock in a harbor and from the dock in the harbor to the offshore area, wherein the temporary location-specific machine learning model is trained by collecting, analyzing and combining datasets of historically collected data of one or more vessels, datasets of external sensors of the one or more vessels, datasets of the harbor related information, the method comprising steps of
predetermining a geographical area of an area of a harbor for keeping the temporary location-specific machine learning model activated during a time the vessel is in the predetermined geographical area;
creating communication by communication means between the harbor operating system and the on-board processing system of the vessel;
receiving a specification of the vessel from the on-board processing system of the vessel, at the harbor operating system, wherein the specification of the vessel comprises at least one of an identification of the vessel, an information about sensoring capabilities of the vessel, an information about computational and data processing capabilities of the vessel, an information about software environment of the vessel;
receiving a request for the temporary location-specific machine learning model from the on-board processing system of the vessel, at the harbor operating system;
preparing at least one software container according to the received specification of the vessel, wherein the at least one software container comprises the temporary location-specific machine learning model;
providing the at least one prepared software container comprising at least one of a license key, a digital rights management method, a limited subscription time, coordinates of a limited location based on the predetermined geographical area for a temporary activation and deactivation the software container and an activation means of the at least one software container from the harbor operating system to the on-board processing system of the vessel;
after providing the at least one prepared software container, activating the at least one software container received by the on-board processing system of the vessel by using the provided software container activation means for providing data to the on-board processing system of the vessel for controlling at least one of a navigation of the vessel, a course of the vessel, a path planning, an identification of a surrounding object types, a location estimation and obtaining a heading data of the vessel in the predetermined geographical area of the area of the harbor.

2. The method according to claim 1, wherein the method further comprises:
confirming that the vessel has entered to the predetermined geographical area of the harbor; and
running the provided temporary location-specific machine learning model of the at least one software container as a part of the on-board processing system of the vessel provided that the confirmation is positive.

3. The method according to claim 1, wherein deactivating the temporary location-specific machine learning model is performed automatically based on at least one of time limits, location limits, expiration of the license, digital rights management method.

4. The method according to claim 1, wherein the software container comprising temporary location-specific machine learning model is provided to the vessel via a transmitter installed at a navigation station at sea.

5. The method according to claim 1, wherein the software container comprising temporary location-specific machine learning model is transmitted to the vessel via communication means at the shore.

6. The method according to claim 1, wherein the method further comprising enabling
continuously collecting datasets from multiple data sources for continuous training of temporary location-specific machine learning model;
initiating the activated software container to assist the on-board processing system of the vessel at navigation by the temporary location-specific machine learning model of activated software container within the predetermined geographical area; and
deactivating the software container when the vessel has departed the predetermined geographical area by disabling or disabling and removing the software container from the on-board processing system of the vessel.

7. A system for providing a temporary location-specific machine learning model from a harbor operating system to an on-board processing system of a vessel for assisting the vessel to navigate between multiple harbors, from an offshore area to dock in a harbor and from the harbor to the offshore area, wherein the temporary location-specific machine learning model is trained by collecting, analyzing and combining datasets of historically collected data of vessels, datasets of external sensors of the vessels, datasets of harbor related information, the system comprising
a communication means;
at least one server connectable to the harbor operating system;
wherein the server comprises
the harbor operating system adapted to communicate through the communication means with at least one vessel, the at least one vessel comprising at least one computing means, a sensor system and the on-board processing system;
the temporary location-specific machine learning model,
wherein the server is configured
to store information defining predetermined geographical area for keeping the temporary location-specific machine learning model activated during the time the vessel is in the predetermined geographical area;
to receive a request for the temporary location-specific machine learning model from the on-board processing system of the vessel;
to prepare at least one software container comprising the temporary location-specific machine learning model;
to receive the specification of the vessel via the automatic identification system, wherein the specification of the vessel comprises at least one of an identification of the vessel, an information about the sensoring capabilities of the vessel, an information about the computational and data processing capabilities of the vessel, an information about the software environment of the vessel;
to provide the at least one software container comprising at least one of a license key, a digital rights management method, limited subscription time, coordinates of the limited location based on the predetermined geographical area for temporary activation and deactivation the software container and an activation means of the at least one software container to the on-board processing system of the vessel via the communication means;
and the on-board processing system is configured to activate the at least one software container received by the on-board processing system of the vessel by using the at least one provided software container activation means to provide data to the on-board processing system of the vessel for controlling at least one of the vessel's navigation, course, path planning, identification of the surrounding object types, location estimation and obtaining or identifying heading data of the vessel in the predetermined geographical area of the area of the harbor.

8. The system according to claim 7, wherein the prepared software container comprises temporary location-specific machine learning model comprising a model selected from a group of
a model for detection and classification of vessel types and seamarks;
a detection and classification model for detecting and classifying vessels in the area of the harbor with minimized false positive detections;
a model for automatically detecting, identifying and classifying landmarks and relevant features for navigation of the area of the harbor;
a model for object detection and classification from camera systems and 3D lidar point cloud data;
a radar and sonar clustering model;
an audio detection and classification model.

9. The system according to claim 7, wherein the prepared software container further comprises a training data collector module for optimization of the temporary location-specific machine learning model.

10. The system according to claim 9, wherein the training data collector module is configured to collect vessel traffic data from at least one vessel sailing in harbors and to provide the collected data to the harbor operating system for further training of at least one location-specific least machine model.

11. The system according to any of the claim 7, wherein the software container further comprises a digital rights management application configured to execute an activation or a deactivation of the software container which is initiated via the predetermined geographical area controlled by the automatic identification system.

12. The system according to any of the claim 7, wherein the system further comprises an automatic identification system connectable to the server, wherein the server is further configured
to communicate with the automatic identification system via the communication means;
to confirm that the vessel has entered to the predetermined geographical area of the harbor using information from the automatic identification system;
and the on-board processing system is further configured
to initiate to assist the on-board processing system of the vessel at navigation by the temporary location-specific machine learning model of activated software container, when the vessel has entered to the predetermined geographical area, during the time the vessel is in the predetermined geographical area, and
to deactivate or to deactivate and remove the software container, when the corresponding vessel has left the predetermined geographical area.
